(19) United States
(12) Patent Application Publication
(10) Pub. No.: US 2004/0151347 A1
(43) Pub. Date: Aug. 5, 2004

(54) Face recognition system and method therefor

(76) Inventor: Helena Wisniewski, Gaithersburg, MD (US)

Correspondence Address: Jean C. Edwards, SONNENSCHEIN NATH & ROSENTHAL LLP, P.O. Box 061080, Wacker Drive Station, IL, 60606-1080, US

(21) Appl. No.: 10/622,512

(22) Filed: Jul. 21, 2003

Related U.S. Application Data
(60) Provisional application No. 60/396,751, filed on Jul. 19, 2002.

(51) Int. Cl. G06K 9/00

(52) U.S. Cl. 382/115

(57) ABSTRACT

A method and system for automated face recognition overcomes operational difficulties such as: face finding problems, inability to recognize some ethnic groups, inability to enroll users, pose, and being too slow for high volume usage. The automated face recognition system uses a new face finding and an automated eye finding approach combined with an intelligent metric. A small template size of the face biometric (biomatrix), of under 90 bytes, is provided, which allows templates to be placed on any size chip or into two dimensional (2-D) barcodes for self-authenticating documents, as well as for quick easy transmission over the internet, wireless devices, or Ethernet (i.e., LAN, WAN, etc.). The small template also provides quick identification and authentication speed, as well as minimal storage requirements, small processing requirements, and increased processing speed. The system can be included in dolls, games, auto theft deterrent systems and drowsiness detection systems.

The present invention claims priority from U.S. Provisional Patent Application No. 60/396,751, filed Jul. 19, 2002, which is herein incorporated by reference.

### BACKGROUND OF THE INVENTION

1. Technical Field of the Invention

The present invention relates to the field of automated face recognition systems for the authentication or identification of human faces. In particular, the present invention relates to fast, automatic human identification using, for example, freeze frame video or digital photographs, for the identification or authentication of human faces for physical and logical access using a computer system, including wireless platforms, and including mass market systems, such as, for example, dolls, games, drowsiness detection, and auto theft deterrent. Further, the present invention is particularly well suited for self-authenticating travel documents (i.e., passports, visas) that use a smart chip or bar code, or transmission applications (i.e., internet, wireless, satellite), in particular those restricted to a small amount of storage, thus requiring a small template.

2. Description of the Related Art

In the field of automated face recognition systems, there have been difficulties in identifying members of varied ethnic groups, poor accuracy, inability to enroll, and the slowness of the current systems for many applications. Further, automatic face finding, and normalization fails for some subjects, and the large size of templates causes problems with the speed and transmission bandwidth. The focus has been mostly on matching engines, not system deployment issues and therefore automated face finding and automated eyefinding have not been a focus of most approaches leading to significant errors during deployment.

The three most widely used automated face recognition methods are eigenfaces, neural nets, and wavelets. The “Eigenface Method”forms the basis for a number of face recognition technologies. The standard Eigenface method treats the entire face image equally. It provides a compression of the data that permits use on a variety of applications. However the size of the individual templates are still large, in the kilobyte range. Since the “Eigenface Method” does no modeling of the human face, and thus, does not attempt explicitly to identify particular features and their quantitative relationships, but rather relies on simple pixel by pixel correlation of images that happen to contain faces, the primary requirement for a successful system is to be assured of capturing a good image of any subject's face. While this seems simple in a laboratory environment, it becomes very difficult in the field. Local feature analysis is a variation on eigenfaces, but eigenfaces are a part of the underlying procedure.

Neural networks have also been tried as a solution to the many errors encountered in realistic operational face recognition systems. However, the drawback to neural networks is the slow speed as it learns (i.e., processing time to train), processing power to train and following training to identify users, and large templates.

There are three separate error sources that appear prominent in any realistic implementation of a face recognition system. They are: normalization (i.e., finding the face in the image, and then the eyes in the face), pose (i.e., presentation of the face to the camera), and lighting (i.e., quality of the illumination of the face in the image).

Normalization refers to the process of putting a face image into a standard position, and suitable size and orientation for comparison with other face images. For a successful normalization it is important to have an accurate face finding approach and eye locating approach. Face images of overlap are used to ensure that the users are to be identified. Correct normalization will also ensure recognition across various ethnic groups. Once the face is discovered in the camera's view, the size and translation of the location of the image is needed to produce an image of the face with the same size and location as the reference images. To ensure that the eyes are in the correct location, the system uses the fact that all human eyes are located the same distance apart.

Producing a “normalized” face image or “template” is the greatest source of error in fielded face recognition systems. A small error in face finding will result in an error in face recognition unrelated to the difference in the images themselves; they simply do not “line up” well. Any successful face recognition system must strive to eliminate normalization error to the maximum extent practical.

Many other systems use a manual adjustment which are cumbersome, time consuming and not real time and are not part of the deployed automated system, since only those that use human intervention in the identification process can benefit from the manual intervention. Such systems are not suitable for real-time identification or authentication.

Pose refers to the presentation of the face to the camera—the angle of the face direction to the line between the camera and the face. A change in pose clearly results in a change in the captured image. If the poses differ between two images of the same person, then an error in correlation of the two images will result. Pose, however, unlike normalization, is not an algorithmic error. It results from the presentation of the face to the camera by its owner. Therefore, correction for pose error must occur in the operation of the face recognition system, itself. If all individuals attempting to gain access by means of a face recognition system, would always present the same pose to the camera, then pose error would disappear.

Lighting is the most obvious and most subtle error source for face recognition. Clearly, a poorly illuminated face will yield a poor image. Essentially, the most desirable illumination is even and omni-directional (diffuse). This may not correlate with “bright”. In fact, bright illumination is prone to glare or specula reflections. Specula reflection is that of a mirror, and can occur with any reflective surface, including the human face. What one sees in a mirror is the light source, not the surface of the glass. In just the same way, specula reflection from a face image in a face recognition system results in the system correlating a facial surface with the light source—a clear source of error.

Thus, these three areas must be corrected in order to improve the accuracy of current face recognition systems. Additional areas of improvement needed for mass market applications include increased identification speed, smaller storage requirements, ability to enroll all users, small processing power requirements, ability to use less expensive standard cameras.

Thus, in order to solve the problems of the current face recognition systems, the applications/fields of use need to develop an intelligent metric to significantly improve the accuracy of the face finding method and automated eye finding method.

Problems with accommodating poses need to be resolved, as well as providing smaller templates to achieve higher recognition speeds, as well as on-line transmissions over limited bandwidths or large volumes of simultaneous users over larger bandwidths. Allowance for self-authenticating documents, in particular, needs to be resolved, particularly on limited chip space and in 2-D barcode.

Further, the applications for face recognition technology require significantly higher accuracy (less false positives and negatives) on at least an order of magnitude, as well as ease of use, at a lower cost, a high speed to about one second for a system using a “Smart Card”, and within about three seconds for a cardless version, and a decreased template size to a maximum of bytes. Finally, the face recognition technology should have the ability to work on all ethnic groups.

### SUMMARY OF THE INVENTION

The present invention eliminates identity fraud and unauthorized access by using biometrics and makes biometrics accessible to the mass market. The present invention provides fully automated complete biometric products and systems that grant or deny access to facilities, networks, e-transactions, on-line testing, PC's, personal records, and vehicles, etc., with no human intervention. The present system operates with all smart cards and can be embedded into a two dimensional 2-D barcode for self-authenticating documents. The present system also operates with a smart camera platform for both wireless and Ethernet applications. The present systems are easy to install, encode and enroll.

A biometric one-pass system according to one embodiment of the present invention, provides a one-step process to produce tamper resistant identification cards (biometric badges) that enrolls, encodes the biomatrix onto the smart card chip, and produces any printed information required on the face of the badge in one easy step with one easy system.

The present system operates with most smart card readers, so that multiple card readers can be used.

Additional benefits of the present invention are to make life simpler (streamlining passenger travel, and making it safer), and provide new forms of entertainment (i.e., on-line video games and dolls).

The present invention provides for unique applications (i.e., drowsiness detection, games, dolls, kiosks for student visas and parolees, identity fraud prevention for hospitals and patient privacy, and retail applications including credit fraud reduction, aircraft security (ensuring passengers who receive boarding passes are the ones boarding the plane), authentication of users for the remote control of appliances, self-authenticating documents (visas, passports, etc.)), with a small template size, high speed, and improved accuracy. Further, the present face recognition system requires simple hardware of only a low-end camera for physical access and a web cam for a desk top, in addition to a computer and smart card reader for the carded version.

The automated access products of the present invention convert a live image into a digital biomatrix of under 88 bytes, compares it to one or more stored biomatrices in a central database and/or on a smart card or in 2-D barcode, and returns access permission or denial in one second—without the use of PINs or passwords.

In one embodiment consistent with the present invention, a method of providing access, includes the steps of capturing an image of a subject; performing a head finding process of said image; performing an eye finding process of said image; and normalizing said image.

In another embodiment consistent with the present invention, the method of providing access includes the steps of sampling the fixed background to develop a statistical model of the background prior to capturing the image, and performing a subtraction of the fixed background to obtain the image.

In another embodiment consistent with the present invention, the method of providing access includes the step of receiving an input of personal information and access privileges of the subject after the image is captured.

In another embodiment consistent with the present invention, the head finding process includes the steps of tracing a contour of a head and shoulders of the image to determine where the head ends and the shoulders begin, and placing said head in a standard position with eyes of said subject being disposed in specific pixel locations.

In one embodiment consistent with the present invention, the eye finding process is performed to a formula where an orthogonal matrix, Q, minimizes a difference between a matrix, M, and a matrix product QN, where N is another matrix, such that ∥M−QN∥ is a minimum, and where said orthogonal matrix, Q, minimizes a term: ∥B−QA∥ where A is a result of said head finding process, and B is a fixed reference image in the standard position, such that strong features of image A are transformed into corresponding features of image B.

In another embodiment consistent with the present invention, the method of providing access includes a normalization step, where Q rotates eye locations in image A into eye locations in image B, which yields eye locations for image A and places image A into said standard position.

In another embodiment consistent with the present invention, the method of providing access includes the step of performing an identification process of the image.

In another embodiment consistent with the present invention, the identification process includes using a weighting function, v, which is applied to the image and which places a greater weighting on differences in eyes-cheek-nose-mouth regions of the image.

In another embodiment consistent with the present invention, a numerical template of the image is no more than 88 bytes.

In another embodiment consistent with the present invention, the method of providing access includes the step of performing an authentication process of the image.

In another embodiment consistent with the present invention, the identification process further includes comparing a numerical representation of the image captured by the image capturing device to a numerical representation of the stored images.

In another embodiment consistent with the present invention, the authentication process includes determining whether a distance between the numerical representation of the captured image and each of the stored images is less than an authentication threshold.

In another embodiment consistent with the present invention, the method of providing access includes notifying the subject as to whether an identity of the subject is authenticated.

In another embodiment consistent with the present invention, the method of providing access includes storing the captured image in one of a database and a smart card.

In another embodiment consistent with the present invention, the method of providing access includes logging and storing all attempts at access in said database to form an audit trail.

In another embodiment consistent with the present invention, the method of providing access includes monitoring at least one of eye movement using the eye finding process, and head movement using the head finding process, to detect drowsiness.

In another embodiment consistent with the present invention, drowsiness is determined when the at least one of eye movement and head movement reaches a predetermined threshold value, and when the predetermined threshold value is reached, an alarm is triggered.

In another embodiment consistent with the present invention, a method of detecting drowsiness in a driver operating a vehicle, includes monitoring at least one of eye movement and head movement of the driver; and triggering an alarm when the at least one of eye movement and head movement reaches a predetermined threshold value.

In another embodiment consistent with the present invention, a method of performing security on passengers traveling on a vehicle includes encoding a passenger's biomatrix on a boarding pass; and comparing said biomatrix to a predetermined database of passengers.

In another embodiment consistent with the present invention, the method of performing security includes taking a second biomatrix of the passenger prior to boarding; and comparing the second biomatrix to the biomatrix encoded on the boarding pass.

In another embodiment consistent with the present invention, a method of providing personalized game play to a user, includes receiving a selection of a character for personalized play in a game; capturing an image of the user; and replacing the character in the game with the image of the user.

In another embodiment consistent with the present invention, the method of providing personalized game play includes converting the image of the user to a biomatrix, and using the biomatrix to generate a face of the user for replacement with the character in the game.

In another embodiment consistent with the present invention, a toy includes means for recognizing a face of a user; and means for notifying the user whether said face is recognized.

In another embodiment consistent with the present invention, the toy includes recognition means including means for capturing an image of the user; means for performing a head finding process of the image; means for performing an eye finding process of the image; means for normalizing the image; and means for identifying the image.

In another embodiment consistent with the present invention, the identifying means includes means for comparing a numerical representation of the image to a numerical representation of stored images.

In another embodiment consistent with the present invention, the toy includes means for authenticating the user, wherein the authenticating means includes means for determining whether a distance between the numerical representation of the captured image and each of the stored images is less than an authentication threshold.

In another embodiment consistent with the present invention, the toy includes notification means including a speaker which delivers a voice prompt, and includes means for recognizing a voice of the user.

In another embodiment consistent with the present invention, the toy includes image capturing means which is a camera disposed in eyes of the toy.

In another embodiment consistent with the present invention, a method of providing access, includes the steps of capturing an image of a subject against a fixed background using an image capturing device; normalizing the image; performing an identification process of the image; and performing an authentication process using the image.

In another embodiment consistent with the present invention, a method of enrolling a subject in a biometric system, includes the steps of capturing an image of the subject using an image capturing device; performing a head finding process of the image; performing an eye finding process of the image; normalizing the image; and storing the image.

In another embodiment consistent with the present invention, a system for providing access, includes means for capturing an image of a subject; means for performing a head finding process of the image; means for performing an eye finding process of the image; and means for normalizing the image.

In another embodiment consistent with the present invention, the system for providing access includes means for identifying said image and means for authenticating the image.

In another embodiment consistent with the present invention, the system for providing access includes means for notifying the subject as to whether an identity of the subject is authenticated, and means for storing the captured image in one of a database and a smart card.

There has thus been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a flowchart depicting the enrollment and normalizaton process according to one embodiment consistent with the present invention.

FIG. 2 is a flowchart depicting the identification process according to one embodiment consistent with the present invention, for the one-to-many identification process against a database (the cardless version).

FIG. 3A is a flowchart depicting the Access Control system using a smart card (insertion contact or contactless), or 2-D barcode, according to one embodiment consistent with the present invention.

FIG. 3B is a perspective exploded view of a contactless smart card used with the Access Control system according to one embodiment consistent with the present invention.

FIG. 4 is a flowchart depicting the Online Control system according to one embodiment of the present invention.

FIG. 5 is a flowchart depicting the Logon Control system according to one embodiment consistent with the present invention.

FIG. 6A illustrates auto theft deterrent system and drowsiness control system using the face recognition system according to one embodiment consistent with the present invention.

FIG. 6B illustrates the board used in the system of FIG. 6A.

FIG. 7 illustrates a process for a passenger boarding pass which uses the face recognition system according to one embodiment consistent with the present invention.

FIG. 8 illustrates a doll which uses the face recognition system according to one embodiment consistent with the present invention.

FIG. 9 illustrates a game which uses the face recognition system according to one embodiment consistent with the present invention.

### DETAILED DESCRIPTION OF THE INVENTION

The present invention provides fully automated complete biometric products and systems that grant or deny access to facilities, networks, e-transactions, on-line testing, PC's, and vehicles, etc., with no human intervention, and corrects for the problems of current face recognition systems with respect to normalization, pose and lighting and improves the matching engine with an intelligent metric.

Hardware Requirements

In one embodiment, the system for the present invention is a self-contained unit, for example, that has a camera, computer microprocessor, an Intelligent Metric system embedded on a chip of a smart card, and a card reader (for the smart card version) of no larger than, for example, 12 inches by 6 inches, with a monitor for visual presentation of the rendered face. Hand held units for use on vehicles or on the spot identification/authentication, can also be provided.

The system includes a processor which has a program which performs the enrollment, identification, and authentication processes of the face recognition system. The board includes a CPU with a processor, at least one memory which stores the biomatrices or templates, and which stores an audit trail for example, and provides connections to visual displays and external databases, for example.

In particular, the standard hardware requirements for the present face recognition system include, for example, a stand-alone single 500 MHz (i.e., Pentium™ III by Intel Corporation) compatible personal computer (PC), with base RAM of 512 MB and a 10 GB hard drive. This allows the disk storage of about 2.8 million individuals' faces. The overall search speed for the system is 2.8 million per minute.

The stand-alone computer can be replaced with a processor in a dedicated multiple processing system if it includes the RAM and disk space as specified for each computer processing unit (CPU). To increase the overall search speed, the number of CPUs can be increased accordingly. For example, to search 20 million in one minute would take 7 CPUs as per the above specification. The system according to one embodiment of the present invention, can use multiple processors and additional storage to maintain system response time with the addition of additional subscribers.

Alternatively, increasing resources while keeping the number of subscribers constant leads to improved system response time. In less than one second, the products can authenticate an individual person and grant or deny access.

The present invention uses an operating system such as the Windows 2000™ operating system by Microsoft Corporation, for example, but can be modified to work with other operating systems. The present invention is not database-specific and works with other databases by, for example, MS SQL Server, Access™, and Oracle Corporation.

For face capture and input, the present invention uses a standard video camera with, for example, a minimum 640×480 resolution. To generate the database for facial searching, or to create an identification card, enrollment can be done with, for example, either a video camera or a digital camera.

For wireless applications the smart camera provides a portable or stationary solution with an easy installation (further described below).

Open Architecture Approach

The present invention uses an open architecture approach, to maximize compatibility and allow easy upgrades of new components. Open sourced Application Program Interfaces (APIs), for example, are used to meet functional performance.

To provide the maximum flexibility in using video imagery, the present invention uses, for example, Microsoft Corporation's Direct Show™ video API. Direct Show™ API provides numerous low-level video processing functions that the present invention utilizes in its video capture and normalization processes. Also, Direct Show™ API allows multiple operations on the images simultaneously. With Direct Show™ also permitting the present system to process multiple video streams simultaneously, multiple access points can be controlled with a single processing unit.

Standard SQL queries are used to store and retrieve data from each product's central database. For every product, the database is implemented as a network DNS. To facilitate customer requirements for access to a database ranging from the tens to the tens of millions of files, the programming restrictions of the Open Database Convention (ODBC) are strictly adhered to so that the present invention's applications will work with small, medium and large (i.e., by Oracle Corporation) databases.

Other instances of the open architecture approach are provided by the various digital (smart) card equipment that is supported by the present invention. The system operates with all smart cards, 2-D barcode and smart card readers. Each is supported via its exported API.

Common Denominator—Enrollment

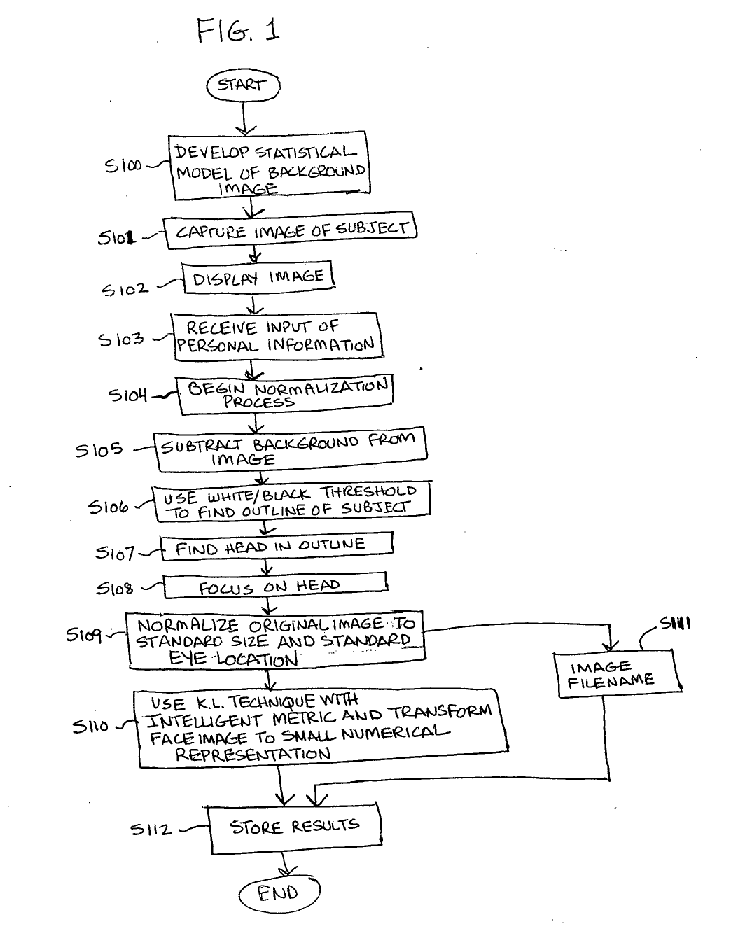

FIG. 1 illustrates the enrollment process and system, known as the Intelliface Transform Process, which is an internal application common to all the applications of the present invention. This system allows the means through which a biomatrix is captured and enrolled into all of the applications.

The principal components according to one embodiment of the present invention, include a video or digital camera, the camera PC interface, the Smart Card reader and writer, and the face recognition engine using the Intelligent Metric. The hardware described above allows for optimum performance.

In the present invention, face recognition is primarily for the purposes of controlling access to resources, and thus, the installation of the present invention occurs in locations with fixed backgrounds for its input images. Thus, the program of the present system continually samples the fixed background so as to develop a statistical model of the background in step S100, taking an average of n frames.

Lighting correction is accomplished by the system as part of the present system installation. Where additional lighting is called for, it can be provided. Where glare develops from existing or ambient light sources, screens or other blocking devices can be provided to remove it.

When the user approaches the camera, the camera captures the poses made by the user in front of the camera system in step S101 (i.e., a still picture from a video). The system administrator provides instructions to the user (i.e., such as moving the head to various angles, and preventing certain eye movement such as blinking).

Eliminating or reducing pose error requires cooperation from the subjects. One approach is to use simple “training” for the subjects. When individuals are enrolled into the present access system, they practice presenting a consistent pose to the camera.

A complementary approach is to enroll multiple images—each with a separate standard pose such as up, down, left, right—so that the live images are compared with multiple poses of the enrolled individuals that are already stored. This second approach works well, but has the cost of increasing the biomatrix size by the number of additional poses used. The present invention make a number of poses a customer selectable parameter that is pre-entered by the system administrator.

The program displays the image of the face of the user captured by the video camera or digital camera in a display window for the system administrator, in step S102, and the program can receive, in step S103, personal information entered via a dialog box, by the user, including the user name and personal ID, and the access privileges (i.e., the hours that an individual is allowed access).

At this point, the program puts the image through the Head Finding and Eye Finding process referred to as the “normalization” process in step S104. Normalization refers to putting a face image into the Standard Positions, which is defined as an image of size Hₚᵢₓₑₗₛ by Vₚᵢₓₑₗₛ with the subject's eyes in specific pixel locations—(H_{leye}, V_{leye}) and (H_{reye}, V_{leye}). To ensure a fair comparison of images, the program of the present face recognition system puts images of the faces into the Standard Position in step S104.

Since the system is used for controlling access to resources, and the background is fixed, the Head Finding process takes advantage of the fixed background and the statistical model prepared by the program. Thus, the program removes the background of an image with a face present, by means of simple image subtraction in step S105.

Thus, when the program detects a large change in the image, it subtracts a representative of the background model from the new image using a simple pixel threshold to replace the (nearly) unchanged pixels in the result in step S106. The set of “non zero” pixels defines the changed portion of the image—i.e., the head and shoulders of the subject. Having localized the head and shoulders, the program of the present face recognition system more precisely locates the head by tracing the contour of the head and shoulders to determine where the head ends and the shoulders begin in step S107.

The program then shifts and expands (or contracts) a rectangle containing the head, to a Hₚᵢₓₑₗₛ by Vₚᵢₓₑₗₛ image in step S108. This image is not yet normalized because there remains uncertainty as to the precise location of the eyes. However, the altered image is now ready for the Eye Finding process.

Given an image processed through the Head Finding process represented by a matrix, A, the Eye Finding process relies on the Orthogonal Procrustes Problem defined by I. Borg and P. Groenen in their paper “Modern Multidimensional Scaling: Theory and Applications”, Springer-Verlag, New York, Inc., New York, 1997. The solution to the Orthogonal Procrustes Problem finds an orthogonal matrix, Q, that minimizes the difference between a matrix, M, and the matrix product QN, where N is another matrix. That is, it determines an orthogonal matrix, Q, so that: ∥M−QN∥ is a minimum.

The Eye Finding process uses the Method of Procrustes by determining the orthogonal matrix, Q, that minimizes the term: ∥B−QA∥ where A is the result of the Head Finding process, and B is a fixed reference image already in the Standard Position. In order to cause the above term to be a minimum, the matrix Q, transforms strong features of image A into the corresponding features of image B. The consistently strongest features in a face image are the eyes. Thus, Q rotates the eye locations in A into the eye locations in B. Since the eye locations in B are already known, this method yields the eye locations for image A. This precise knowledge of the eye locations in A permits the present program to complete the process of placing image A into the Standard Position, thereby completing normalization in step S109. Eye finding plays a critical role in obtaining a more precise result in matching the live image against a Smart Card image or database.

The present normalization process yields consistently accurate determination of eye locations in images containing faces. Furthermore, since it uses background subtraction, scenes with a busy background are no more difficult to process than are scenes with a featureless background, in contrast to other methods of normalization. Also, the innovative Eye Finding process of the present invention consists of a simple calculation, not a series of hypothesis formulation followed by hypothesis testing, as in most other normalization algorithms. This calculation always uses the same amount of processing time, so that the normalization is consistent in processing time as well as in accuracy.

Once the Head Finding and Eye Finding processes have taken place, a face print or biomatrix of under 88 bytes (template), is generated by the program in step S110, given a filename in step S111, and stored by the program in step S112 in the database or on a Smart Card chip, if used. This step S110 is further described in the Identification and Authentication process below, with respect to transforming the face image to a small numerical representation.

Thus, the user is enrolled in the system and when the user presents their face to the system again, an identification and authentication process, as discussed below, can ensue.

Identification and Authentication Process

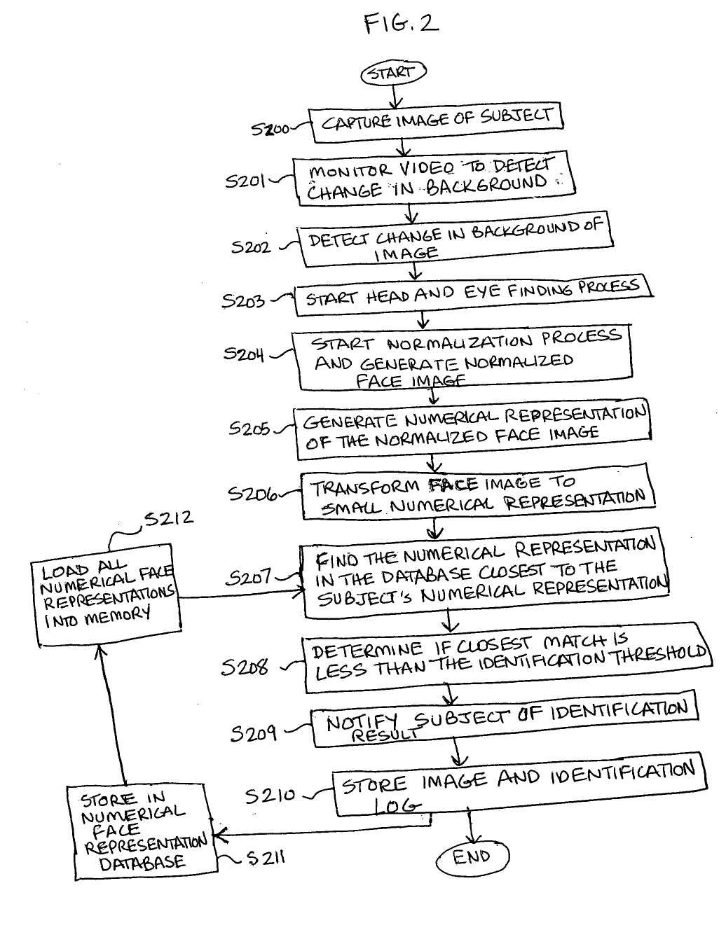

When the user presents his face to the camera system again, after being previously enrolled, the normalization process begins again (see FIG. 2 for the Identification Process).

With respect to normalization, the present invention takes advantage of the fact that for automated access control systems, the image background is unchanging. Thus, face finding and subsequently, the normalization of the face image can make use of this unchanging background, enabling the present face recognition system to rapidly and consistently locate the subject face in the general image. Thus, when the subject looks at the camera and the camera captures the subject's image in step S200 of FIG. 2, the program, which has been monitoring the images captured by the camera or image capturing device in step S201, and will note a change in the background in step S202.

Briefly, the approach of the present invention relies on differentiating images with the subject present, and the images of the background. The difference, simply put, is the subject. From this difference the face and the eye location can be determined, thus, achieving good normalization.

Automated authentication/verification (one-to-one) or identification (many-to-one) of live images for access control is first to find the face, and then the eyes. If the video camera does not locate an actual face, or locating a face does not correctly find the actual eyes in the face, then a poor match will result no matter how good the matching algorithm is.

The Head Finding and Eye Finding processes are thus carried out as discussed above in step S203. The present normalization process in step S204, yields consistently accurate determination of eye locations in images containing faces. Furthermore, since it uses background subtraction, scenes with a busy background are no more difficult to process than are scenes with a featureless background, in contrast to other methods of normalization.

Also, the innovative Eye Finding process consists of a simple calculation, not a series of hypothesis formulation followed by hypothesis testing, as in most other normalization algorithms. Also eye finding is automated, in contrast to using a manual adjustment by other systems. This calculation always uses the same amount of processing time, so that the normalization is consistent in processing time as well as in accuracy. The consistent performance of the present method, results in access control systems whose users can expect correspondingly consistent performance. Other face recognition systems suffer from occasional sluggish performance when they encounter a face or background different from the norm, which is not a flaw suffered by the present system.

Thus, once the normalization process has been completed, the present face recognition system proceeds with identification and authentication of the face. Contrary, to the conventional Eigenface method, the present invention uses an “Intelligent Metric” in step S205, which is a weighting function applied to the face images that emphasizes the features that are most different in a face within the golden triangle region (i.e., encompassing the eyes, nose, cheeks, and mouth, which psychological research indicates that people rely on to identify other people), versus the other parts of the face. Using the Intelligent Metric of the present invention in the matching function results in pixel variation in the eye region, for example, to play a more significant part in identification than pixel variation in the forehead. Its application in step S205 emphasizes what differs the most between various faces. Implementation of the Intelligent Metric has a definite improvement on the systems' matching discrimination and speed.

In particular, the present face recognition technology uses the Karhunen-Loeve (KL) Method (see M. Kirby and L. Sirovich, “Application of the Karhunen-Loeve Procedure of the Characterization of Human Faces”, IEEE Transactions on Pattern Analysis and Machine Intelligence, Vol. 12, No. 1, pp. 103-108, January 1990) with a modification—to result in the Intelligent Metric of the present invention. Since KL produces an Orthogonal Function Decomposition of the Cross Correlation matrix of the set of images, it depends on a Vector Space metric, μ. This metric is ordinarily just the standard Square Root of the Sum of Squares of the vector space components. However, other metrics will still produce an Orthogonal Function Decomposition.

The present invention's face recognition system uses a metric that emphasizes the portions of a face image producing the most discrimination between individuals. This metric, v, places a greater weighting on differences in the eyes-cheek-nose-mouth regions of the face than on other regions. This weighting takes place in the autocorrelation matrix where the expected values incorporate a weighting function. The autocorrelation matrix, which represents an average of the deviation of all the faces is where each pixel is assigned a different weighting value; unlike the eigenface method which does not assign weightings to the pixels. Regions of the face that carry the least useful information for recognition, such as the forehead, receive less weight in the present invention's technology.

The increased discrimination that the metric, v, provides, allows the present invention's face recognition system to operate with a greatly compressed numerical template—of under 88 bytes. This small size is important for applications in which bandwidth use is a critical design feature. It is also important for encoding the present invention's face template on limited storage devices such as smart cards. As such, KL with the Intelligent Metric, v, provides face recognition performance that surpasses other technologies.

The Intelligent Metric of the present invention applies the weighting factor as follows:

Let V=V(px, py) be the variance function on a set of normalized images, where (px, py) is a pixel location in the picture grid. Each pixel location has a variance. Then the Intelligent Metric is calculated from the regular distance metric by dividing at each point by the variance that that point. So v(px, py)=m(px, py)/V(px, py), where m is the distance metric, and v is the Intelligent Metric.

The program then directs the Intelligent Metric to transform the face image to a small numerical representation (see step S206) which is then used to compare with other stored templates in step S207 (the stored templates being loaded into memory in step S212 from a numerical face representation database S211). The confidence value is the difference between the stored face template of a subject and the template produced from the live picture of the face recognition system. The smaller the difference, the larger the confidence value. The calculation of the confidence value is: Confidence Level=10/(1+template difference/16).

The face recognition system then identifies and authenticates the user based on the above, in step S207, and a predetermined Authentication Threshold of step S208 (i.e., if the distance between the two numerical representations is less than the Authentication Threshold, the subject is authenticated). If the user is not identified (i.e., the distance between the two numerical representations is more than the Authentication Threshold), the subject is notified by the program in step S209, and the image of the face stored for future comparison in step S210. All attempts are logged and stored in the system by the program in steps S209-210.

Smart Cards

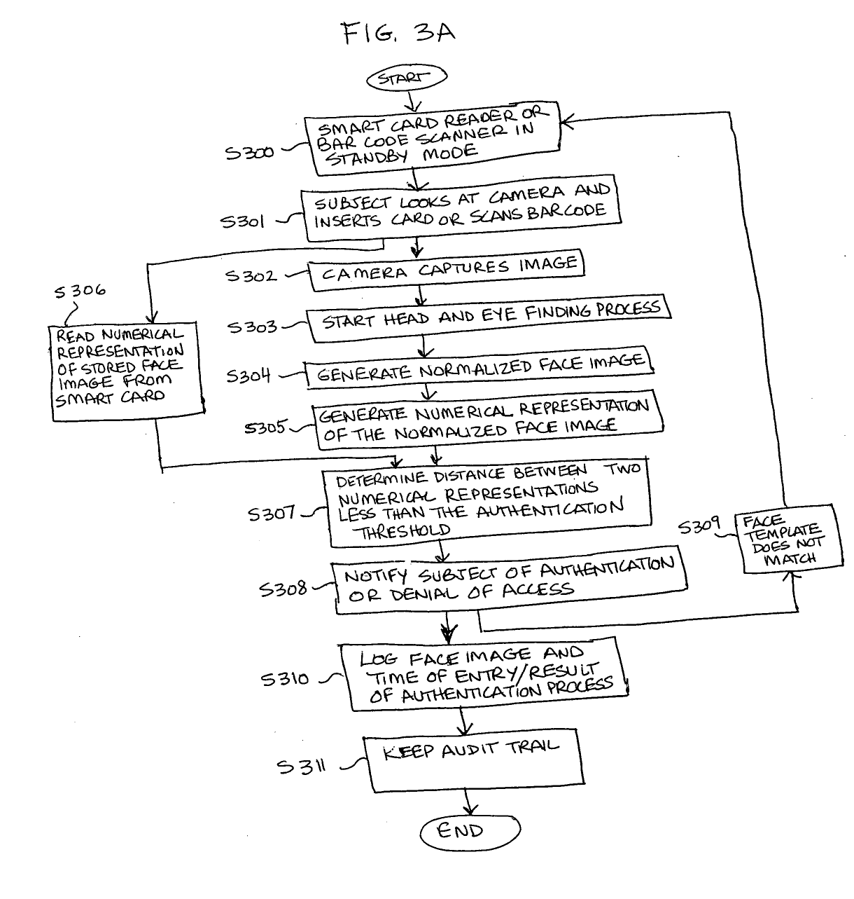

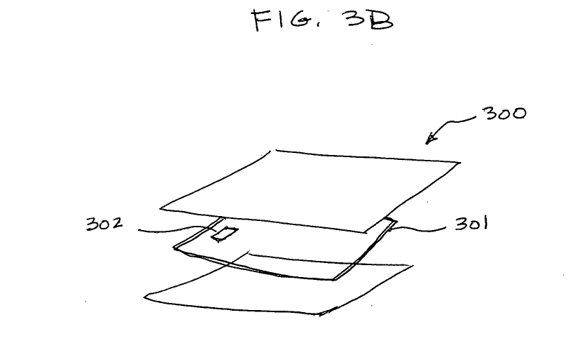

The use of Smart Cards which have encoded biomatrices provides a versatile option (see FIG. 3A) in one embodiment consistent with the present invention.

The biomatrix of the user, which with the present system is only under 88 bytes, is encoded on a chip or bar code or magnetic strip for cards (see FIG. 3B), both requiring physical contact with the card reader (insertion contact), or contactless cards. Contactless Smart Cards 300 contain an embedded antenna 301 instead of contact pads attached to the IC chip 302 for reading and writing information contained in the chip 302 memory. Contactless cards 300 do not have to be inserted into a card acceptor device. Instead, they need only be passed within range of a radio frequency acceptor to read and store information in the chip 302. The range of operation is typically from about 2.5″ to 3.9″ (64.5 mm to 99.06 mm)) depending on the acceptor. The authentication would take a second.

Also, the biomatrix can be used on cards with satellite transmission capabilities where the biomatrix would be transmitted for authentication of the user. This requires a small template which the present invention provides (only under 88 bytes), and high speed. The biomatrix could be used for biometric authentication badges, credit cards, national ID cards, driver licenses, and any type of card that would require a biometric print on it for verification purposes. Passports and visas could use a 2-D barcode with the biomatrix embedded in the bar code.

The use of a Smart Card with the face recognition system of the present invention is described below in Applications, for Physical and Logical Access.

Applications

The present invention has a number of unique applications

Physical and Logical Access Control

In one application for access control, the present invention provides a web-enabled verification system for local or universal access across geographically dispersed locations (see FIG. 3A). The Access Control system can be deployed with or without a Smart Card component. For the Smart Card selection, the Access Control system is provided with either a wired card reader or a wireless (RF) component.

The Access Control system is depicted in FIG. 3A, which includes enrollment (see above and FIG. 1) which is required. This enrollment can be performed at a point of access or at a specified enrollment station. For biometric badges, the Biometric Access Control System would provide the user with both a “conventional” badge with picture, company logo, etc., as well as the 84 biomatrix encoding with a single process.

The Access Control system is primarily, a web-enabled system, and communication protocols can be handled as HTTP web messages. HTTP is used for messaging between modules into data fields, and messages are sent in HTML and XML, to grant or deny access to an individual.

The Access Control system consists of a video camera, camera computer interface, modem, the standard Intelligent Metric PC system, actuator, and Smart Card reader. The minimum specification for the video camera is 640×480 resolution. This is a standard video camera, available at any computer supply store at a reasonable cost.

As shown in FIG. 3A, the Access Control process is designed to illustrate the use of a contactless Smart Card, and if a Smart Card is not used, the associated steps in the process can be eliminated. In this embodiment, a Smart Card Reader or Bar Code Scanner is disposed at the point of access, and is in standby mode in step S300 until activated.

The user then inserts the Smart Card (or with the contactless Smart Card walks past the reader) in step S301, and looks at the camera. The video camera captures the face in step S302, and starts the head and eye finding process in step S303. Then, the program generates the normalized face image in step S304, which is translated by the program in step S305 into a numerical representation of the normalized face image, and into a face print of under 88 bytes (as discussed above with respect to Enrollment (see FIG. 1)).

The program reads the face print on the Smart Card in step S306, and compares the captured image with the face print on the Smart Card in step S307, to determine if the distance between the two numerical representations are less than the authentication threshold. Simultaneously, in step S306, the Smart Card is read by the program and any personal information such as authorized access times to facilities or designated areas, are verified by the program. Then the program determines if the subject is authenticated and notifies the subject in step S309.

If the permission in the database is acceptable, and the templates from the camera and on the card match, then the subject notified by the program that the subject is authenticated by the actuator, which is connected to the entry, unlocking the door. This process takes no more than one second.

If permission is not granted from the database, or the face templates do not match, then permission is denied by the program and the subject is notified by being denied access. If just the face template does not match, the program provides the option to redo the live picture at this point, and the process can be repeated in step S309. If the process fails again, access is denied by the program but the picture of the person is kept and the time of entry recorded by the program in step S310 for security reasons, and an audit trail is kept of these events by the program in step S311 (see Audit Control below).

Thus, pictures are kept during access attempts to create an audit trail in steps S3110-311, and provide a recent picture of the person in the database. If a person who is authorized gets consistently denied, then perhaps the face template needs to be updated to reflect changes in the face due possibly to aging or other changes.

The Access Control system uses two types of Smart Cards: one contact type, which needs to have physical contact with the reader, and the other a contact-less type which can be read without physically contacting the reader. The selection of the appropriate Smart Card type will be up to the organization.

If a Smart Card is not used, the face print created by the video capture of the face, is transmitted and compared by the program in step S307 against an enrolled authorized user database. The permission is either granted or denied by the program in steps S308-S309. These will also be used as biometric authentication badges.

In wireless camera applications, the processing of the algorithm of the present invention is performed on the camera and templates can be stored on the camera, or kept in a central database. In addition to access control, portable checks against a watch list can be easily done at entrances to tunnels, ports, or facilities. The system can be easily updated and records also duplicated and preserved in a central database. The smart camera also provides a compact, easy to install unit.

Online and Logon Control Systems

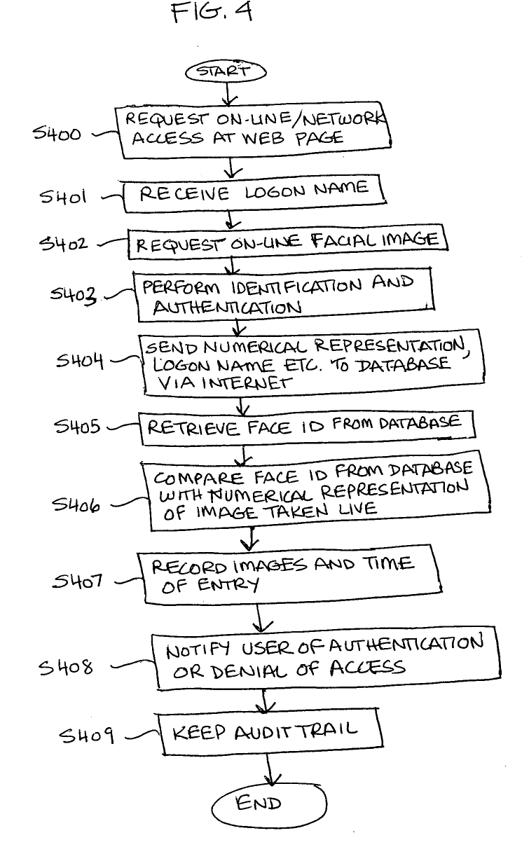

Further, another application would be for providing an authentication system for ensuring authorized user access to networks or databases—i.e., the Online Control system (see FIG. 4). The Online Control system could have enterprise-wide as well as local area network (LAN) applicability. The Online Control system grants access to authorized personnel and records failed attempts to get access.

In this application, the system includes a video camera, a PC, camera computer interface, modem, and the standard Intelligent Metric PC system.

Users turn to the web pages, and request network access in step S400. The user enters, for example, a logon name which is received by the program in step S401. Then the program begins an authentication procedure by requesting an on-line facial image in step S402. The video camera capture of the face is the same as for the facility access used in the Access Control system. The program then would proceed with the identification and authentication process as described previously in the Access Control system, in step S403, and then the numerical representation or template is sent via the internet to a database in step S404. A numerical representation of the image is retrieved in step S405, and in step S406, the templates are compared to determine the confidence value.

The user is notified of the user's authentication or denial of access in step S408. Thus, with this system, that instead of unlocking a door, the Online Control system unlocks the network resource and logon is completed. If unauthorized users try to gain entry onto a network, their pictures are recorded, as well as the time of the failed entry as in previous descriptions, in step S407, and the denial of access is displayed. Thus, an audit trail is kept by the program in step S409.

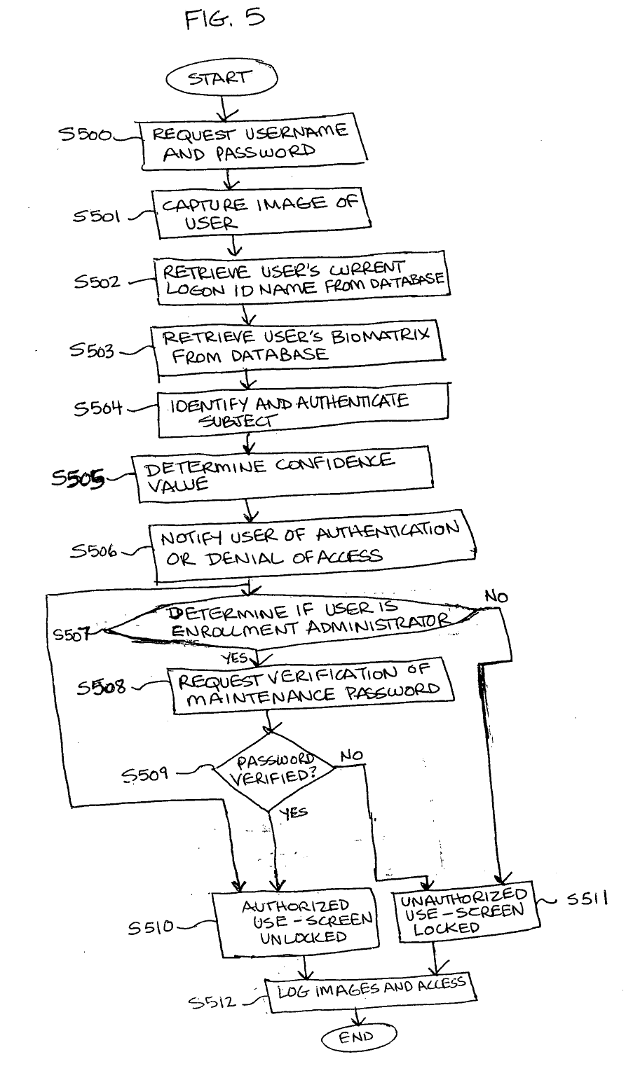

Still another application would be to provide an interactive authentication system for use with PC's—the Logon Control system (see FIG. 5). This ensures that only authorized users receive access to the PC. This provides remote on-line access for telecommuters or for financial transactions, and provides positive access control for PC resources, making the resource unavailable whenever the user leaves the immediate vicinity of the PC.

The Logon Control system uses the face, instead of the password, to facilitate PC access. If unauthorized users try to logon, their pictures are recorded, as well as the time of the failed entry, as described previously. The Logon Control process is illustrated in FIG. 5.

When users turn on the PC, their username and password are requested by the program in step S500. The user types in a user name and their face acts as their password. The video camera or USB camera capture of the face in step S501 is the same as for the facility access used in the Access Control system.

Thus, the program retrieves the user's current Logon User ID name in step S502, and the user's biomatrix in step S503 from a database. The database is on a server accessed over an intranet or internet. The program then proceeds, as in the Access Control system, in step S504, to authenticate the user's live picture. In step S505, the program determines whether the user is authenticated by determining the confidence value, which is the difference between the stored face template of the user and the template produced from the live picture of the face recognition system, as described previously. The user is then notified of the authentication of denial of access in step S506. If the user is authenticated, instead of unlocking a door as previously described with Access Control, the Logon Control system unlocks the computer device and logon is completed in step S510. If the user is not authenticated, the user is notified of the denial of access in step S511. The images and logs of entry are kept for an audit trail in step S512.

In one embodiment, for example, if the logon user is an Enrollment Administrator, then in step S507, the program requests verification of the maintenance password in step S508. If the maintenance password is verified by the program in step S509, then the images and log of successful access are logged in step S512. If the program determines that the logon user is not an Enrollment Administrator in step S507, or if the maintenance password is not verified by the program in step S509, then the program proceeds to log the biomatrix of the attempted user and makes a log of the access in step S512.

When the user leaves the computer, the Logon Control program shuts down the computer, and goes into a “screen saver” mode. When the authenticated user returns, the program directs the camera to take a picture of the user in step S501, and if the user is authenticated as previously described, then in step S510, the program unlocks the computer, and the computer is re-activated by the program.

If the user is not authenticated, and unauthorized persons are attempting to get onto the computer, the program keeps the computer locked in step S511, and the pictures and times of failed entry are saved as previously described in step S512. The program then proceeds to the enrollment process to enroll the users in store their biomatrices.

After the user has completed using the computer, the user logs out.

Vehicle Theft Deterrent Application with Drowsiness Detection Option

Vehicle theft is one of the major types of theft in the U.S.

Further, drowsiness is responsible for a majority of the fatal accidents on U.S. highways and is a subject of intensified interest to the Department of Transportation. This interest includes systems, that are non-invasive, and automated to determine the onset of drowsiness and alert drivers in real time, and can easily be incorporated into vehicles. As presented in the article by the Federal Highway administration (see R. Knipling, P. Rau: “Perclos: A Valid Psychophysiological Measures of Alertness As Assessed by Psychomotor Vilance,” US Department of Transportation, Federal Highway Administration, Publication No. FHWA-MCRT-98-006, 1998.), “one of the most reliable and valid determination of a deriver's alertness level is PERCLOS. PERCLOS is the percentage of eyelid closure over the pupil over time and reflects slow eyelid closure.” A PERCLOS drowsiness metric was established in 1994, and is used by the present invention. The metric is the proportion of time in a minute that the eyes are at least 80% closed. This metric is used as part of the thresholding system in this invention. Since drowsiness manifests itself in certain overt signs in the eye and head movement, this invention provides an automated, noninvasive method to track ocular movement, and head movement using its face recognition method.

The Driver Control system in this invention reduces vehicle theft and increases driver safety. It ensures that the person starting the vehicle is the owner or designated user of the vehicle (i.e., automobile, truck, boat, aircraft, etc.). This system is useful for individual owners as well as fleet operations such as limousine services where multiple non-owners need access to high value vehicles.

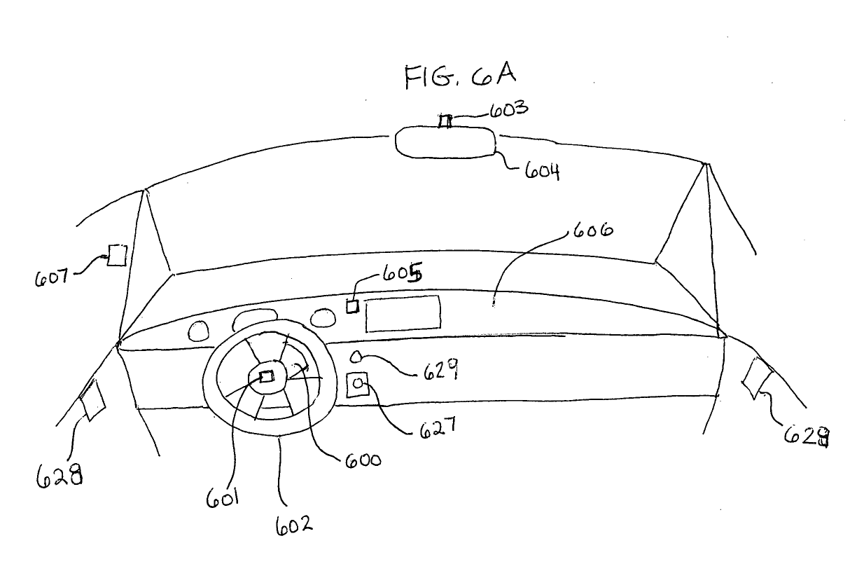

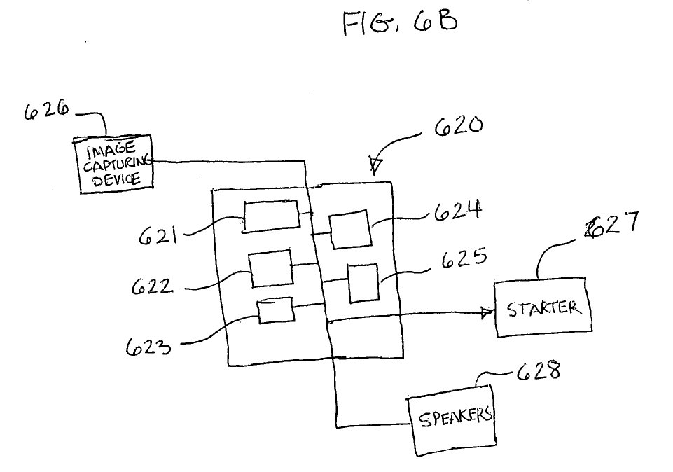

Modification is required for the Driver Control system, for a small unit with the Intelligent Face Metric on a chip and for a small processing unit (see FIG. 6A). The camera location is flexible, but can be preferably provided, for example in a car, in the steering column 600 with the lens 601 in the steering wheel 602; or the lens 603 can be provided in the rear view mirror mounting 604 for easy adjustment by the driver; or the lens 605 can be provided in the dashboard 606; or the lens can be provided in the supporting column 607. Further, the camera body may be disposed inside the dashboard 606 and connected to a processor on a board which is disposed in the steering column 600.

The board (see FIG. 6B) includes a processor which has a program which performs the enrollment, identification, and authentication processes described earlier. The board 620 includes a CPU with a processor 621, at least one memory 622 which stores the biomatrices or templates, and which stores an audit trail for example, a video card 623, a voice prompt 624, a connection to an image capturing device 626 such as a camera, an actuator 625 which is connected to the starter 627 of the engine, and a connection to speakers 629 for voice prompts.

When the driver enters the vehicle, the driver must first press button 629, or use a key, to activate the Driver Control system. The driver then looks at the camera, and the program will proceed with the usual steps in the Access Control system described previously, in order to identify and authenticate the driver. If the driver is recognized, the actuator 625 sends a signal to the starter 627, and the driver is able to start the car. The picture of the driver is captured by the image capturing device 626 for the audit trail, and the program initiates the voice prompt to say “Welcome” etc.

If the driver is not recognized, the car will not be able to start, and the program will initiate the voice prompt to say “Access Denied”, and the picture of the attempted user is captured for the audit trail.

Enrollments may be done for the driver and the designated driver. The owner of the car can do time-dependent temporary enrollments for the mechanic or temporary users. The enrollment is performed similarly to those previously described in other applications, and time-dependent enrollments can be entered via a keypad or other device connected to the board and provided in the vehicle.

A drowsiness detection option that can alert drivers or pilots when signs of drowsiness appear is another option. In contrast to current drowsiness systems, this drowsiness detection system is nonintrusive. It is small and can easily be integrataed into a vehicle on a chip. The camera embedded in the vehicle would automatically find the driver's face, then locate the eyes, as with the basic system.

The system would then track and measure eye movement, the percentage of eyelid closure over the pupil over time, and head movement, etc., by using the face finding, eye finding and liveness test portions of the present invention's algorithm. The invention's eye finding and face finding incorporate background subtraction to isolate the eyes and face, which position them to determine variations in movement. For PERCLOS, the amount of eye reflectance and pixel variations is measured to determine coverage of the pupil. For blink rate, the present invention's liveness test is used. For the changes in head movement, both the present invention's liveness test and the K-L method is ideally suited and eigenvectors are used to account for the different variations in each pose and variations among poses.

The camera continually transmits frames to the processor. The processor uses the present invention's methods on each frame transmitted. Every minute the processor performs calculations to determine if the thresholds are met or exceeded to indicate onset of drowsiness. Every minute the system would average the changes in eyelid coverage, blinking, and head movement within that time period. These would be compared against a threshold average. If the onset of drowsiness is indicated an alert would be sent to the driver in form of an alarm. A minute time frame is chosen based on a recommended time from the FHWA for PERCLOS.

Thus, the driver can gain control of the vehicle via the Driver Control system, if present. Then, once the driver is operating the vehicle, the program would then monitor the eye and face movement to determine the onset of drowsiness based on a threshold value previously inputted into the database stored in the system of the vehicle, which would indicate the “precursors” to drowsiness. If they match the movements in the database, indicating drowsiness, the program would activate an alarm, for example the voice prompt or a whistle, for example, alerting the driver or pilot. If the program does not detect drowsiness based on the precursors, then no alarm is sounded.

Passenger Authentication for Boarding Passes

This application combines the features of the Access Control system and the Online Control system. Passengers check-in at automated kiosks, which provide their boarding passes. This insures that the person obtaining the boarding pass is the person who boards the plane. A person's biometrics can be used to check against a “watch list” prior to boarding the plane.

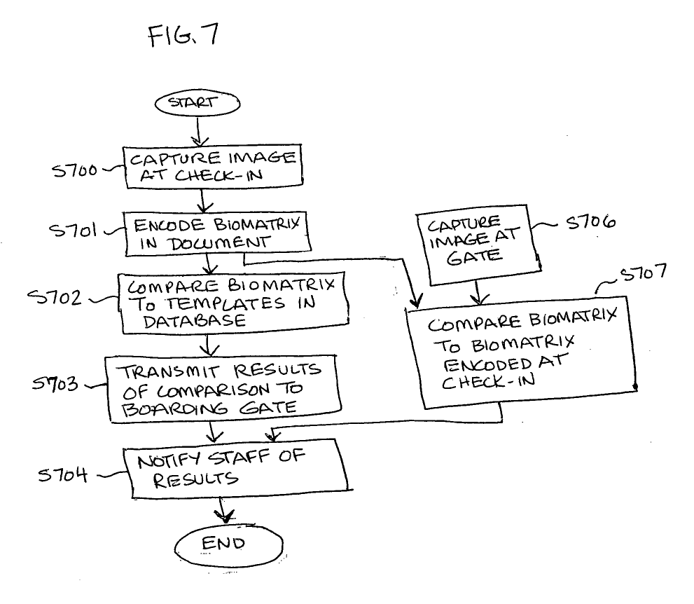

At check in, the passenger's photo is taken in step S700, and his/her boarding pass is encoded with the 84 byte biomatrix (see FIG. 7) by the staff at step S701. Thus, the passenger would have his/her biomatrix of under 88 bytes encoded at check-in (or for frequent flyers, and club members, on their cards) in step S701. While moving through the security process, their under 88 bytes would be simultaneously compared by the program to a database of persons who are being sought (i.e., terrorists, etc.) in step S702. Results of the database match are transmitted in step S703 to the boarding gate by the program and the staff alerted during review of the passenger list in step S704. If a match is found, appropriate persons are notified by the program such that they may take action. If there is no match in the database to a person being sought etc., then after review, those passengers may board the aircraft or ship etc. in step S705

In another embodiment consistent with the present invention, at the gate, before boarding, a second picture is taken automatically and unobtrusively upon boarding by the passengers passing a strategically located camera in step S706. The passenger looks at the camera, the system converts their live image into their biomatrix, and simultaneously their boarding pass is scanned in step S707. Then only if their biomatrix matches the one on the boarding pass can they board the aircraft. If not all passengers with tickets have boarded the aircraft or ship etc., then the program alerts the staff in step S704 such that the no-show passengers will have their luggage removed.

Biometric Badges and Universal ID cards

The present system can also be used for universal ID cards for airport/airline personnel access, critical facility access and frequent flyer cards for frequent flyers. With these personnel, a background check could be performed and this information, as well as their biometrics placed on the travelers' frequent flyer cards. Such travelers could proceed to a different, quicker security check-in, for example, if they are authenticated.

In other applications, authentication of students boarding school buses, dormitory access, laboratory access, on-line exams, long distance learning, student and teacher ID's, security personnel, etc., can be provided.

Health Care Industry

One of the greatest concerns is insurance card fraud, where extended family members or friends use one card and have personal information they recite at check in to a medical facility. With the face recognition system of the present invention, when a patient checks-in they would be required to look at a camera of the present system. The program would convert their live picture to their biometric and compare it to those enrolled in the database. If a match is found by the program, the program accesses the patient's records. This also insures patient privacy of records, since only those authorized can gain access to patient information. Further, human error is eliminated at check in. Their biometric can also be embedded in the insurance card which can be read at check-in.

In the health care industry, additional applications include: surgery access, nursery access, pharmacy access, patient check-in, and patient tracking, which can all be performed using the present system.

Dolls (Includes Stuffed Animals)

“Doll” in this description refers to baby dolls, stuffed animals, robots, and other types of dolls. The doll would recognize its owner and acknowledge the owner with a phrase such as: “I see (child's name)”. If it does not recognize the person holding them, it would say a phrase such as: “I want my Mommy—I do not know you,” or start crying.

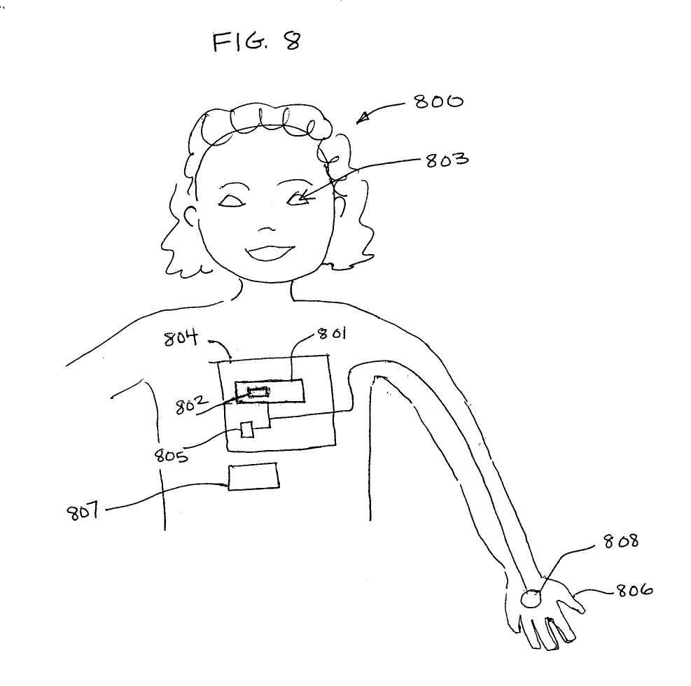

The doll 800 (see FIG. 8) would have a small processor 801 and the system on a chip 802 inside it, with a camera 803 embedded in the head and would “see you” through its eyes. The child would enroll using the doll as well, and would be able to enroll friends or family for recognition. The basic system would be a merged, smaller version of the Enrollment system, and the Access Control system described previously.

The camera 803 will be a pin-hole type, with resolution of 330 TV lines, in an eye of the doll 800 and connected to the processor 801 through the neck of the doll. In the body of the doll would be a small board 804 with a microprocessor 801 to run the algorithm, memory (for storage of phrases, biomatrix templates etc.), and a chip 802 with the following algorithm components: face finding, enrollment, and matching. The processor 801 could also be in the head of the doll 800 depending on the size of the doll.

In the back or the belly of the doll 800, for example, would be a switch 805 with the following settings: on, off, reset and enroll. If the switch is set to on, to activate its face recognition would require the person to depress the hand 806 which would activate the system, and then the person would look into the eyes (or camera 803) and be recognized. The doll 800 would also have a voice recognition part in the board 804 which would provide instructions for enrollment and announce recognition via a speaker 807 disposed in the belly or mouth of the doll 800, for example. The stomach of the doll would have “holes” to allow for the sound from the speaker 807 disposed therein, for example. The doll 800 could be held as far away as 12 inches for recognition of the user. The doll would run on batteries, and come with a “recharging” unit. The connection would be in the rear of the doll, for example.

Enrollment process: To enroll directly with the doll 800, the switch 805 would be set to “enroll,” the hand 806 squeezed, for example, and the program would have the doll say “look at me”. Then the child would look at the eyes with the doll held at about 12 inches from the face and the child would say his/her name. The camera 803 would take the child's picture, and the program would convert the live image into the 84 byte biomatrix that is unique to the child and store it in memory. When enrollment is complete, the program would have the doll 800 say a phrase such as “thank you.” If a good enrollment is not obtained, the program would have the doll say “try again”.

Enrollment process using a PC: This version comes with a CD for the PC, and a cable to connect the doll to the computer. With this version the user would type the child's name instead of saying it. Therefore, the voice recognition component would not be necessary in the doll. The CD would have the enrollment software. The instructions would be on the CD instead.

The process would be to first download the CD, then connect the doll to the PC. Once the PC connections are completed, the program would provide a menu to request that the child's name be typed. Then the user would set the switch on the doll to “enroll,” squeeze the hand, for example, and the program would have the doll say “look at me”. Then the child would look at the eyes with the doll 800 held at about 12 inches from the child's face. The camera 803 would take the child's picture, the program would convert the live image into the 84 byte biomatrix that is unique to the child and store it into memory.

The system would also be able to act similarly to the Access Control system, and allow the user to take a number of poses, from which a composite is taken. The software of this embodiment will show the faces from the poses, for example 5 poses, from which the composite is made (this process is not visible in the other enrollment version) and the algorithm (i.e., Intelligent Metric) is applied to it. If the enrollment is not satisfactory, in this version, the person performing enrollment will see the problem as well and the program will display an advisory on the PC monitor that enrollment was not satisfactory and that the user should try again. When enrollment is complete, the program will have the doll say a phrase such as “thank you.”

Recognition: The user should turn the switch to off, after enrollment, then. back on. This puts the program of the doll 800 into the recognition mode. The child squeezes the hand 806 of the doll, for example, then looks at the doll, and the program makes the doll say “I see (child's name)”. If a child who is not enrolled squeezes the doll's hand and looks at the eyes, the doll 800 will recite a phrase such as “I don't know you” or “I want my Mommy.” The doll 800 can be programmed for a variety of phrases when the child is not recognized, which are stored in memory.

If the system is providing recognition of the child, then the switch should be put to “reset” by the user, and the child can re-enroll. Friends and family can be also enrolled and will be recognized by the doll.

There is also a “refresh” button 808 which can be provided in the hand of the doll 800, for example, which causes the doll to reset also for re-enrollment.

Electronic Games

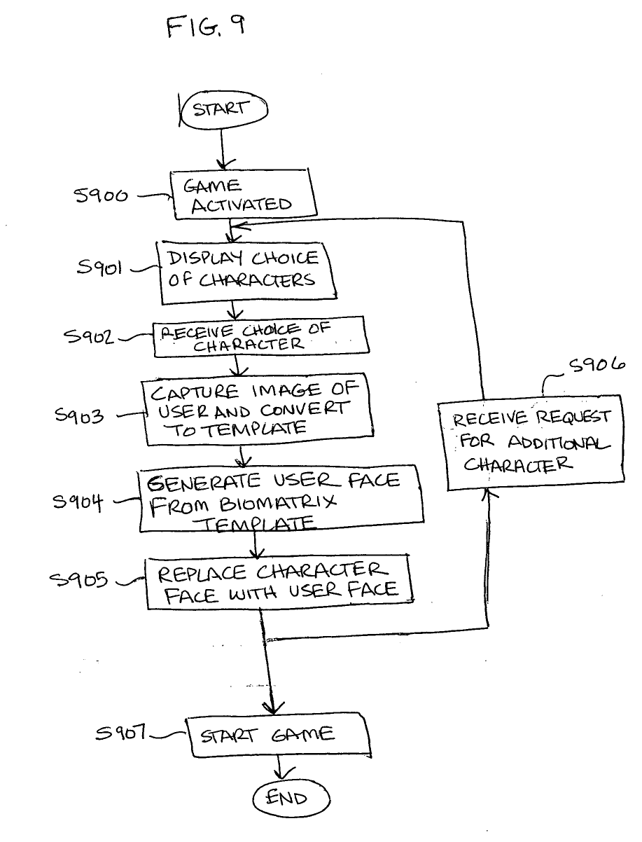

There will be two parts to this application: 1) authentication of the user, and 2) the face of the user would become the face of the character of choice. A friend could also enroll and they could become characters in the game (see FIG. 9). The authentication system would be similar to the Online Control system, and assuming the faces of the character in the game would depend on whether its an on-line game or TV game or hand held game. For the on-line versions, a web Cam camera could be used, for the hand held versions, either a web cam like camera or a camera embedded in the hand-held device would be used.

Once the user turns on the game in step S900 system The program would display on screen a choice of characters in step S901, and the player would choose one by mouse clicking on it, for example, in step S902. Then the program will command the camera to take a picture of the user, and to convert the live picture to the biomatrix of under 88 bytes in step S903, with this picture being transmitted to the game program. The program would then generate the face of the player from the biomatrix in step S904 and place it on the face of the character in the electronic game in step S905. The process can be repeated in step S906 so that other players can also enroll and choose a character, and then the game can start in step S907.

For online games, the game would first authenticate the player as previously described in the Online process, and then the process is similar to that for the computer games.

Remote Control of Household Appliances and Homes

Although the user can remotely access activation of appliances using current technologies, only the present invention provides authentication to ensure that only authorized persons can activate the appliances. The Online Control system would be used for this application, where the user can access through an internet or intranet, the appliances.

Also, the remote control application includes on-site appliance control for “smart houses” to verify who the user is, and activate the appliances accordingly. Also, latch key kids can be identified, and gated community access can be provided using the present invention.

Smart Passports and Visas

With the present invention, the fraudulent use of visas and passports can be prevented, as well as the ability to track temporary visas, or to check for aliases. A chip with the 84 byte biomatrix would be embedded in the passport or visa. The biomatrix could also be embedded in a magnetic strip or barcode on the passport or visa. The biomatrix could be taken at the time of the passport or visa application. When a person wishes to gain entry to the U.S., and presents their passport, the camera takes their live picture, the program converts it to their 84 byte biomatrix, and compares it to the biomatrix on the passport or visa as previously described. Only if the biomatrices match, is the person allowed entry. This ensures that only the person who obtained the passport is presenting it at the border entrance. The same applies for border crossing cards. This would use both the Enrollment and Access Control systems described previously.

For tracking temporary visas, such as student visas, periodic check-ins at designated kiosks could be required to ensure the location and identity of the holder. Also, to ensure that the visa is not expired, kiosks would be linked to the INS or the appropriate agency. This application would use the Access Control system previously described with an internet link to the appropriate agency.

Financial Transactions

In this application, a smart chip is encoded on a credit card with the 84 byte biomatrix. The Online Control system also allows authentication of the user. If used at the point of sales, the present invention can help eliminate credit card fraud. The Access Control system previously described can also be used for this application.

If the user does not want their biomatrix kept in a central database, it can be placed on the credit card itself by using a chip (like a smart card chip previously described), or in a 2-D barcode.

Banks and financial institutions also can use the present system at ATM machines, for general facility access, on-line account security, vault access, and for on-line banking.

Time and Attendance Systems

The Access Control system allows an audit trail. Thus, organizations can track access and attempted access to their secure resources. Each time that an access attempt occurs with any of the systems, a record of the attempt—a verification log entry—is recorded by the program in the system's central database. Verification log entries contain at a minimum, the following information:

1) time of access attempt;

2) picture of individual making the attempt;

3) picture of both the individual making the attempt, and the authorized individual in the case of a Smart Card;

4) access station for the attempt (i.e., door number, network portal, etc.)

5) numerical match value.

If access is granted as a result of an access attempt, then the following additional information is stored:

1) individual gaining access;

2) Smart Card ID (if the system uses one).

With this information stored in the database, system managers can obtain a variety of reports detailing the access activity for the secure resource to which the biometric access system is applied. Examples of the reports are:

1) access attempts by time of day;

2) unsuccessful access attempts;

3) access activity by individual employees;

4) time and attendance.

The functionality provided by Audit Control function allows resource managers to have extensive knowledge about the use and potential misuse of an organization's secure resources. The database queries used in the Audit Control function are written in standard SQL, so that they will apply with little alteration with any Open Database Convention (ODBC) compliant database. This means that Audit Control function is easily ported to any number of operating systems environments.

Accessing Personal Records

In order to gain access to a personal record the biometric of the person presenting themselves must match that encoded in the record file. For example, when a person registers at a hospital, the camera takes the picture, converts it to the 84 byte biomatrix and compares it to those in the database. When a match is found by the program, the personal record of the person is accessed. This will prevent unauthorized persons from accessing personal or health files of individuals. This can be used to protect private records such as health records.

Summary

Thus, as stated above, in order to solve the problems of the current face recognition systems, the applications/fields of use have developed an Intelligent Metric to significantly improve the accuracy of the face finding method and automated eye finding method.

To accommodate poses, an average of poses is found at enrollment. The smaller templates of only under 88 bytes, for example, provide higher recognition speeds as well as on-line transmissions over limited bandwidths or large volumes of simultaneous users over larger bandwidths. It also allows for self-authenticating documents, in particular, those with limited chip space on smart cards, and in 2-D barcode.

Further, the applications for face recognition technology with regard to games and toys require smaller templates, and high speed. To make the face recognition system mass market more available, all the applications require significantly higher accuracy (less false positives and negatives) on at least an order of magnitude, ease of use, at a lower cost, a high speed to about one second for a system using a “Smart Card” and within three seconds for a cardless version, and a decreased template size to a maximum of bytes, and ability to work on all ethnic groups.

Thus, the present invention improves accuracy by an order of magnitude over other face recognition products—optimized for an equal error rate of 0.001. The present invention provides consistent performance whether ten, or tens of thousands, or hundreds of thousands, of persons use a system. Automated verification takes under a second. Furthermore, a face print requires only under 88 bytes, and versions of the present invention are available with or without Smart Cards. Thus, the present invention provides a low cost, easy implementation, which allows validation of the access rights of clients to various locations.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of providing access, comprising:
capturing an image of a subject;
performing a head finding process of said image;
performing an eye finding process of said image; and
normalizing said image.

2. The method according to claim 1, wherein said subject is placed against a fixed background.

3. The method according to claim 2, further comprising:
sampling said fixed background to develop a statistical model of said background prior to capturing said image.

4. The method according to claim 3, further comprising:
performing a subtraction of said fixed background to obtain said image.

5. The method according to claim 1, further comprising:
receiving an input of personal information and access privileges of said subject after said image is captured.

6. The method according to claim 4, wherein said subtraction replaces pixels of said fixed background with zero, and non-zero pixels define said image.

7. The method according to claim 6, wherein said head finding process comprises:
tracing a contour of a head and shoulders of said image to determine where said head ends and said shoulders begin.

8. The method according to claim 7, wherein said head finding process further comprises:
placing said head in a standard position with eyes of said subject being disposed in specific pixel locations.

9. The method according to claim 8, wherein said eye finding process is performed to a formula where an orthogonal matrix, Q, minimizes a difference between a matrix, M, and a matrix product QN, where N is another matrix, such that ∥M−QN∥ is a minimum.

10. The method according to claim 9, wherein said eye finding process is performed to a formula where said orthogonal matrix, Q, minimizes a term: ∥B−QA∥ where A is a result of said head finding process, and B is a fixed reference image in said standard position, such that strong features of image A are transformed into corresponding features of image B.

11. The method according to claim 10, wherein said normalization step includes Q which rotates eye locations in image A into eye locations in image B, which yields eye locations for image A and places image A into said standard position.

12. The method according to claim 1, further comprising:
performing an identification process of said image.

13. The method according to claim 12, wherein said identification process includes using a weighting function, v, which is applied to said image and which places a greater weighting on differences in eyes-cheek-nose-mouth regions of said image.

14. The method according to claim 1, wherein a numerical template of said image is no more than 88 bytes.

15. The method according to claim 12, wherein at least one pose of said subject is stored as an image in said image capturing device.

16. The method according to claim 15, wherein a number of poses of said subject is pre-selected.

17. The method according to claim 15, further comprising:
performing an authentication process of said image.

18. The method according to claim 17, wherein said identification process further comprises:
comparing a numerical representation of said image captured by said image capturing device to a numerical representation of said stored images.

19. The method according to claim 18, wherein said authentication process further comprises:
determining whether a distance between said numerical representation of said captured image and each of said stored images is less than an authentication threshold.

20. The method according to claim 19, further comprising:
notifying said subject as to whether an identity of said subject is authenticated.

21. The method according to claim 20, further comprising:
storing said captured image in one of a database and a smart card.

22. The method according to claim 21, further comprising:
logging and storing all attempts at access in said database to form an audit trail.

23. The method according to claim 21, wherein said smart card is one of a contact-type and a contactless card.

24. The method according to claim 17, wherein said identification process further comprises:
comparing a numerical representation of said image captured by said image capturing device to a numerical representation of a stored image on a smart card.

25. The method according to claim 24, wherein said smart card is embedded with a biomatrix of said subject.

26. The method according to claim 25, wherein said smart card includes access information on said subject.

27. The method according to claim 26, wherein said smart card is one of a contact-type and a contactless card.

28. The method according to claim 17, wherein said identification process further comprises:
comparing a numerical representation of said image captured by said image capturing device to a numerical representation of a stored image on a database accessed over the internet.

29. The method according to claim 17, wherein said image capturing device is wireless, and said stored images are stored in said wireless image capturing device.

30. The method according to claim 1, further comprising, prior to said capturing step:
requesting an image from said subject when on-line access is requested.

31. The method according to claim 1, further comprising, prior to said capturing step:
requesting an image from said subject when logon access is requested from said subject.

32. The method according to claim 31, wherein said logon access is requested when a computer is directed by said subject to leave screen saver mode.

33. The method according to claim 20, wherein when said identity of said subject is not authenticated, access is denied.

34. The method according to claim 1, wherein access is time-limited.

35. The method according to claim 1, further comprising:
monitoring at least one of eye movement using said eye finding process, and head movement using said head finding process, to detect drowsiness.

36. The method according to claim 35, wherein drowsiness is determined when said at least one of eye movement and head movement reaches a predetermined threshold value.

37. The method according to claim 36, wherein when said predetermined threshold value is reached, an alarm is triggered.

38. The method according to claim 21 or claim 24, wherein said smart card includes an identification card, a passport, a visa, a credit card, a time card, and a boarding pass.

39. The method according to claim 33, wherein said authentication and said denial of access are performed by voice prompt.

40. A method of detecting drowsiness in a driver operating a vehicle, comprising:
monitoring at least one of eye movement and head movement of the driver; and
triggering an alarm when said at least one of eye movement and head movement reaches a predetermined threshold value.

41. A method of performing security on passengers traveling on a vehicle, comprising:
encoding a passenger's biomatrix on a boarding pass; and
comparing said biomatrix to a predetermined database of passengers.

42. The method according to claim 41, further comprising:
taking a second biomatrix of said passenger prior to boarding; and
comparing said second biomatrix to said biomatrix encoded on said boarding pass.

43. A method of providing personalized game play to a user, comprising:
receiving a selection of a character for personalized play in a game;
capturing an image of the user; and
replacing said character in said game with said image of the user.

44. The method according to claim 43, further comprising:
converting said image of the user to a biomatrix, and using said biomatrix to generate a face of the user for replacement with said character in said game.

45. A toy comprising:
means for recognizing a face of a user; and
means for notifying said user whether said face is recognized.

46. The toy according to claim 45, further comprising:
a power source.

47. The toy according to claim 46, further comprising:
means for recharging said power source.

48. The toy according to claim 46, wherein said recognition means comprises:
means for capturing an image of said user;
means for performing a head finding process of said image;
means for performing an eye finding process of said image;
means for normalizing said image; and
means for identifying said image.

49. The toy according to claim 48, wherein said identifying means comprises:
means for comparing a numerical representation of said image to a numerical representation of stored images.

50. The toy according to claim 49, further comprising:
means for authenticating said user.

51. The toy according to claim 50, wherein said authenticating means comprises:
means for determining whether a distance between said numerical representation of said captured image and each of said stored images is less than an authentication threshold.

52. The toy according to claim 45, wherein said notification means comprises:
a speaker which delivers a voice prompt.

53. The toy according to claim 45, further comprising:
means for recognizing a voice of said user.

54. The toy according to claim 48, wherein said image capturing means is a camera disposed in eyes of the toy.

55. The toy according to claim 53, further comprising:
a reset device which resets the recognition means.

56. A method of providing access, comprising:
capturing an image of a subject against a fixed background using an image capturing device;
normalizing said image;
performing an identification process of said image; and
performing an authentication process using said image.

57. A method of enrolling a subject in a biometric system, comprising:
capturing an image of the subject using an image capturing device;
performing a head finding process of said image;
performing an eye finding process of said image;
normalizing said image; and
storing said image.

58 A system for providing access, comprising:
means for capturing an image of a subject;
means for performing a head finding process of said image;
means for performing an eye finding process of said image; and
means for normalizing said image.

59. The system according to claim 58, further comprising:
means for identifying said image.

60. The system according to claim 59, further comprising:
means for authenticating said image.

61. The system according to claim 60, further comprising:
means for notifying said subject as to whether an identity of said subject is authenticated.

62. The method according to claim 58, further comprising:
means for storing said captured image in one of a database and a smart card.
